(19) United States
(12) Patent Application Publication
(10) Pub. No.: US 2026/0135912 A1
(43) Pub. Date: May 14, 2026

(54) IN-VEHICLE NETWORK CENTRAL CONTROLLER, AND METHOD FOR OPERATING IN-VEHICLE NETWORK

(71) Applicant: TRENTO SYSTEMS.INC.

(72) Inventors: Young Jae KIM, Daejeon (KR); Yong Hwan KIM, Daejeon (KR)

(21) Appl. No.: 18/978,749

(22) Filed: Dec. 12, 2024

Related U.S. Application Data
(63) Continuation of application No. PCT/KR2024/017754, filed on Nov. 11, 2024.

(30) Foreign Application Priority Data
Nov. 8, 2024 (KR) 10-2024-0158113

(51) Int. Cl. H04L 67/12; B60R 16/023; H04L 12/40

(52) U.S. Cl. CPC H04L 67/12; B60R 16/023; H04L 12/40; H04L 2012/40215; H04L 2012/40273

(57) ABSTRACT

The present disclosure relates to a method for reducing the number of physical communication lines of an in-vehicle network and securing a data transmission bandwidth and data transfer time (low latency) by applying a network slicing technology in an in-vehicle network based on a software-defined vehicle (SDV).

### CROSS-REFERENCE TO RELATED APPLICATIONS

This is a bypass continuation application of International PCT Application No. PCT/KR2024/017754, filed on Nov. 11, 2024, which claims priority to Republic of Korea Patent Application No. 10-2024-0158113, filed on Nov. 8, 2024, which are incorporated by reference herein in their entirety.

### TECHNICAL FIELD

The present disclosure relates to a method for applying a network slicing technology in implementing an in-vehicle network (IVN).

### BACKGROUND ART

As vehicles become more sophisticated, the importance of basic technologies is growing, along with the need to enhance road safety, provide driver assistance functions, and improve efficiency.

Particularly, with a growing demand for vehicle performance improvement and drivers' convenience and safety, the internal structure of vehicles is changing to a software-defined vehicle (SDV), and accordingly electronic devices (electronic control units) in vehicles are evolving and the number thereof is rapidly increasing.

This change in the internal structure of vehicles to the SDV has generated various types of data in vehicles and also increased the complexity of an in-vehicle network to the level of the existing Internet communication network.

However, for a system to operate smoothly and safely in vehicles as in general computing systems, a technology for reducing the weight of a vehicle while maintaining data transmission capability and dynamically changing and implementing in-vehicle networking is required.

### SUMMARY

The present disclosure has been made in consideration of the above circumstances, and an aspect of the present disclosure is to reduce the number of physical communication lines of an in-vehicle network and to secure a data transmission bandwidth and data transfer time (low latency) by applying a network slicing technology in an in-vehicle network based on a software-defined vehicle (SDV).

To achieve the foregoing aspect, an in-vehicle network central controller for controlling an in-vehicle network according to an embodiment of the present disclosure includes a control function unit configured to establish, in a data plane of the in-vehicle network, a data transmission path for an in-vehicle component registered in the in-vehicle network in a control plane of the in-vehicle network and to generate a dedicated network slicing path separated for the in-vehicle component by virtualizing the data transmission path in order to transmit data of the in-vehicle component.

Specifically, the control function unit may be configured to register the in-vehicle component in the in-vehicle network by obtaining attribute information about the in-vehicle component when authentication of the in-vehicle component is completed according to a registration request from the in-vehicle component.

Specifically, the in-vehicle network may include an in-vehicle network device configured to transmit data of the in-vehicle component in a data link layer, and the control function unit may be configured to generate the dedicated network slicing path in which attribute information about the in-vehicle component is reflected according to a network slicing request from the in-vehicle network device and the in-vehicle component.

Specifically, the in-vehicle network device may include a control plane communication channel for linking with the in-vehicle network central controller in the control plane of the in-vehicle network and a data flow table for transferring the data of the in-vehicle component in the data plane of the in-vehicle network.

Specifically, the control function unit may be configured to determine an in-vehicle component group of a common attribute, based on the attribute information about the in-vehicle component, and to generate the dedicated network slicing path for each in-vehicle component group.

To achieve the foregoing aspect, an in-vehicle network operation method performed by an in-vehicle network central controller according to an embodiment of the present disclosure includes a session establishment operation of establishing, in a data plane of the in-vehicle network, a data transmission path for an in-vehicle component registered in the in-vehicle network in a control plane of the in-vehicle network and a slice establishment operation of generating a dedicated network slicing path separated for the in-vehicle component by virtualizing the data transmission path in order to transmit data of the in-vehicle component.

Specifically, the method may further include a component registration operation of registering the in-vehicle component in the in-vehicle network by obtaining attribute information about the in-vehicle component when authentication of the in-vehicle component is completed according to a registration request from the in-vehicle component.

Specifically, the in-vehicle network may include an in-vehicle network device configured to transmit data of the in-vehicle component in a data link layer, and the slice establishment operation may include generating the dedicated network slicing path in which attribute information about the in-vehicle component is reflected according to a network slicing request from the in-vehicle network device and the in-vehicle component.

Specifically, the slice establishment operation may include determining an in-vehicle component group of a common attribute, based on the attribute information about the in-vehicle component, and generating the dedicated network slicing path for each in-vehicle component group.

According to an in-vehicle network central controller and a method for operating an in-vehicle network of the present disclosure, it is possible to reduce the number of physical Ethernet communication cables of an in-vehicle network and to secure a data transmission bandwidth and data transfer time (low latency) by applying a network slicing technology in an in-vehicle network based on a software-defined vehicle (SDV).

### BRIEF DESCRIPTION OF DRAWINGS

FIG. 1 illustrates an in-vehicle network according to an embodiment of the present disclosure;

FIG. 2 illustrates the configuration of an in-vehicle network central controller and an in-vehicle network device according to an embodiment of the present disclosure;

FIG. 3 illustrates a functional block of an in-vehicle network central controller according to an embodiment of the present disclosure;

FIG. 4 illustrates an example of a method of designing an in-vehicle network according to an embodiment of the present disclosure; and

FIG. 5 to FIG. 9 are flowcharts illustrating a method for operating an in-vehicle network according to an embodiment of the present disclosure.

### DETAILED DESCRIPTION

Hereinafter, exemplary embodiments of the disclosure will be described with reference to the accompanying drawings.

An embodiment of the disclosure relates to a technology for dynamically controlling an in-vehicle network (IVN).

An electronic device has been used in a vehicle for decades, providing enhanced safety and entertainment.

A large number of such functions are designed in an independent form, and do not rely on data of other in-vehicle systems. However, as advantages of system integration have been recognized with technological development, automotive-specific networking technologies have emerged.

General network communication protocols used in a vehicle include a local interconnect network (LIN), a controller area network (CAN/CAN-FD), and FlexRay.

Each solution has a unique attribute and a consideration in design, and has a limitation of not meeting a requirement of a vehicle evolving into a software-defined vehicle (SDV).

Describing the limitation in more detail, the LIN is a cost-effective technology, is suitable for a service device using a low data transmission rate (<20 kbps), and is simple to implement, but has a restriction on bandwidth and is limited to connection to 12 nodes, making it restrictive to apply to the latest vehicles.

The CAN (and subsequent versions, such as CAN-FD) is very robust and relatively less affected by electrical interference and noise and thus widely used in automotive and other safety-critical systems, but is difficult to use in a specific data-intensive application, such as one using an infotainment and a camera, due to a limited bandwidth (generally about 2 Mbps) and has a restriction on the number of nodes.

A new CAN-XL standard is under development to process at higher speed, but a direct switch to Ethernet is recognized as a more suitable solution.

FlexRay offers precise timing and synchronization and thus is suitable for time-critical use, such as drive-by-wire, but has complexity compared to other automotive networks thus limiting use.

When functions, such as an image sensor, a LiDAR module, and a control electronic device, are distributed in a plurality of areas of a vehicle, precise timing alignment and latency time compensation are critical to properly operate time-sensitive functions, such as an advanced driver-assistance system (ADAS).

Therefore, the existing time-sensitive networking (TSN) Ethernet protocol is being reviewed for automotive use, but the TSN standard has not yet been integrated, and thus a compatibility issue between specific devices may arise.

Although TSN is designed to ensure real-time communication, a delay may occur when network traffic increases. Further, since TSN needs to manage various traffic classes and priorities, it may be difficult for a network manager to effectively manage the traffic classes and priorities.

High-bandwidth and low-latency communication using an Ethernet technology has been considered as an alternative to the foregoing traditional in-vehicle network communication, but carrier sense multiple access with collision detection (CSMA/CD) of standard Ethernet, which is the existing Ethernet protocol, is not suitable for applications that require sensitive time control, such as drive-by-wire.

In addition, a TSN technology, which an alternatively Ethernet technology, has increased costs due to increased compatibility and complexity.

However, as a vehicle evolves around an SDV market, manufacturers are switching an in-vehicle network to an Ethernet-based network due to advantages of wideband transmission and compatibility.

Therefore, to apply the Ethernet technology to an in-vehicle network, an Ethernet-based in-vehicle network implementation technology for enabling high-bandwidth and low-latency communication, dynamically and quickly changing configuring an in-vehicle network environment, and reducing the number of physical communication lines is required.

Accordingly, an embodiment of the present disclosure proposes a new method capable of reducing the number of physical communication lines of an in-vehicle network and guaranteeing a data transmission bandwidth and data transfer time (low latency) by applying a network slicing technology as the complexity of the in-vehicle network increases in an SDV.

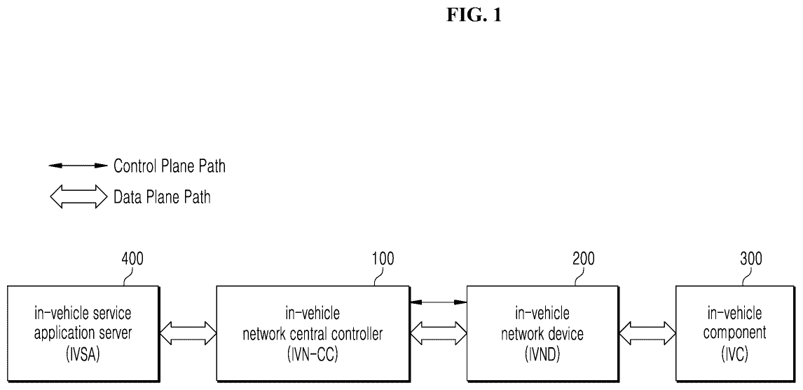

FIG. 1 illustrates an in-vehicle network according to an embodiment of the present disclosure.

As illustrated in FIG. 1, an in-vehicle network environment according to an embodiment of the present disclosure may have a configuration including an in-vehicle network central controller (IVN-CC) 100, an in-vehicle network device (IVND) 200, an in-vehicle component (IVC) 300, and an in-vehicle service application server (IVSA) 400.

Communications between components in the in-vehicle network may separate to function via a control plane path and a data plane path.

A data plane of the in-vehicle network serves to transfer data along a physical path of the in-vehicle network or a virtual dedicated path when necessary.

That is, the data plane serves to forward actual traffic in the in-vehicle network device 200 and the in-vehicle component 300, and includes a function of receiving and transmitting a packet and also a function of transmitting a packet.

A control plane of the in-vehicle network serves to manage and control traffic flow in a session and the network, and includes functions of determining the topology of the in-vehicle network, establishing a path, and applying a policy.

The control plane is executed in the in-vehicle network central controller 100, and serves to control the data plane to properly operate by giving a command to the in-vehicle network device 200, the in-vehicle component 300, and the in-vehicle service application server 400.

In the in-vehicle network environment according to the embodiment of the present disclosure, the control plane and the data plane are separated to configure physical and logical networks, making it possible to connect the in-vehicle network and transmit data by using only a data link layer of seven OSI layers without using an IP.

In particular, data transmission may be performed through a dedicated network slicing path, thereby guaranteeing a transmission speed (bandwidth) and communication delay and ensuring QoS for in-vehicle network communication.

To this end, a control message protocol may use, for example, an application programming interface (API) to which OpenFlow or a dedicated protocol customized for a vehicle is applied.

In the in-vehicle network environment according to the embodiment of the present disclosure, the network slicing technology may be applied based on the foregoing configuration, thereby reducing the number of physical communication lines of the in-vehicle network while guaranteeing a data transmission bandwidth and data transfer time (low latency). Hereinafter, the configuration of the in-vehicle network central controller 100 and the in-vehicle network device 200 for realizing the foregoing purposes will be described in more detail.

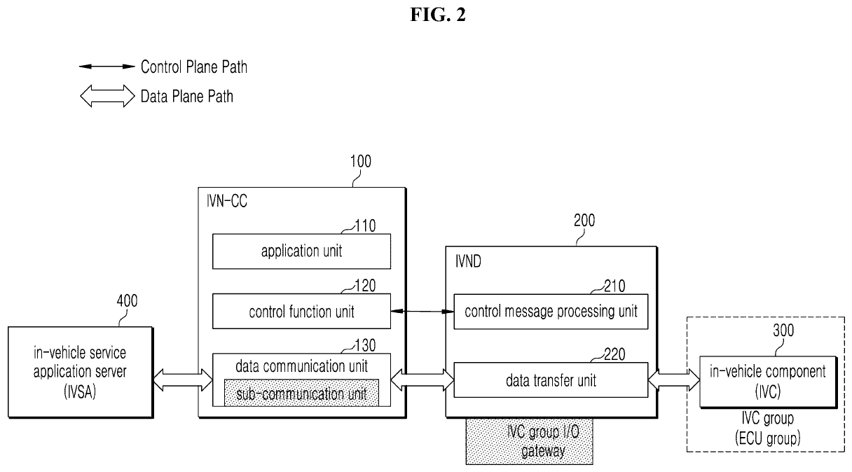

FIG. 2 illustrates a schematic configuration of an in-vehicle network central controller 100 and an in-vehicle network device 200 according to an embodiment of the present disclosure.

As illustrated in FIG. 2, the in-vehicle network central controller 100 according to an embodiment of the present disclosure may have a configuration including an application unit 110, a control function unit 120, and a data communication unit 130.

The application unit 110 serves to virtualize and add an in-vehicle network function, and is responsible for enabling a vehicle designer and operator to perform a function of virtualizing and adding a network function, such as DHCP, a firewall, and NAT.

The application unit 110 may virtualize software of an in-vehicle component 300, and may dynamically group (combine) or separate the in-vehicle component 300 or ECUs of the in-vehicle component 300 according to common attributes, such as a function, performance, a QoS requirement of data traffic, and a traffic path, at the request of a customer and a vehicle manufacturer.

In relation to the above configuration of the in-vehicle component 300, an in-vehicle service application server 400 may perform a function of providing a service requested by the customer and the manufacturer to the in-vehicle component 300.

The control function unit 120 performs a function of physically authenticating the in-vehicle component 300, establishing a session, and generating a dedicated network slicing path for high-speed Ethernet communication under a single central controller by grouping or combining the in-vehicle component 300 or electronic control units (ECUs) of the in-vehicle component 300, based on an area of a vehicle.

That is, the control function unit 120 may control and manage data transmission according to a separate request from an in-vehicle component group (IVC group or ECU group) or the in-vehicle component 300 with a function of dynamically generating a dedicated virtual path (dedicated network slicing path) to the end of the in-vehicle component 300 in a single physical Ethernet cable line, thereby reducing the number of physical communication lines and ensuring the QoS of in-vehicle data traffic.

The data communication unit 130 is responsible for a data communication function in an in-vehicle network, and may include a sub-communication unit for external communications, such as OTA and V2X.

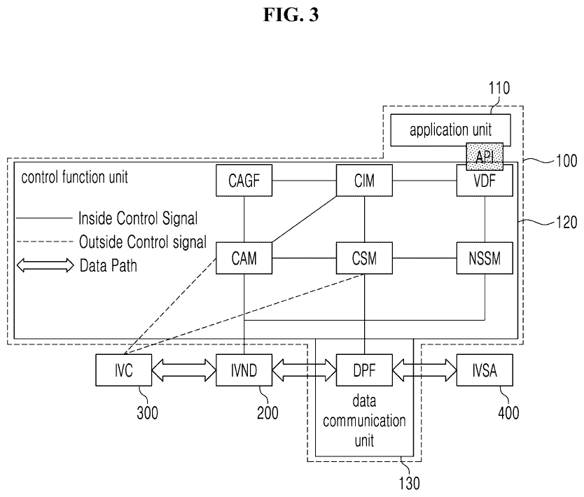

The foregoing components of the in-vehicle network central controller 100 according to the embodiment of the present disclosure may be divided into functional blocks including, for example, a component access management (CAM), a component session management (CSM), a data plane function (DPF), a component authentication group function (CAGF), a component information management (CIM), a data traffic unit (DTU), a vehicle defined function (VDF), and a network slicing service management (NSSM) as shown in FIG. 3.

Each functional block requests information and transmits information for approval via an “inside control signal”, and transmits and controls information with an external device via an “outside control signal”. Each functional block is described as follows.

The CSM manages a connection of the in-vehicle component 300, which may be understood as a function of component registration, a data traffic unit (DTU) size, QoS request information, application service authentication, and replacement management in a repair.

The DTU is a basic unit for transmitting data in the in-vehicle network, and may be used when data is transmitted in each data plane layer and be mainly used to process data traffic required by the in-vehicle components 300.

The CSM manages a connection with a data network in the in-vehicle network and a session of the in-vehicle network device 200 and the in-vehicle component 300, which may be understood as a function of establishing, modifying, and releasing a session.

The DPF is responsible for processing and transmitting data traffic in conjunction with the in-vehicle network device 200 and the data communication unit 130, which may be understood as a function of transferring a data packet, a network slicing path, and applying quality of service (QoS).

For reference, in relation thereto, a network interface card (NIC) may perform functions of layer 1 and layer 2 of the DPF.

The CAGF is responsible for authentication of the in-vehicle component 300 and active grouping of the in-vehicle component 300 according to common attributes (e.g., a function, performance, a QoS requirement, and a traffic path) upon the request of the in-vehicle network central controller 100, which may be understood as a function of processing requests for authentication and grouping (combination) of the in-vehicle component 300 and transferring and managing an authentication result and grouping and separation results to a requesting block.

The CIM provides a function of managing attribute information about the in-vehicle component 300, which may be understood as a function of storing and managing information, such as the profile of the in-vehicle component 300, subscription information, state information, and the valid period of a traffic path.

The VDF performs a function of adding various network functions required by the customer and the manufacturer, and for this purpose, provides an application programming interface (API) for adding a function required for the vehicle through external linkage.

The NSSM perform generation, establishment change, changes, and management of a dedicated network slicing path required by the in-vehicle component 300, which may be understood as a function of monitoring traffic information state and changes of the in-vehicle component 300 and reallocating a network resource to establish and manage the dedicated network slicing path when necessary.

Establishment of the dedicated network slicing path may be performed in a data link layer with only a MAC address without an IP, and accordingly does not require path calculation by the IP, thus being performed without a router.

The in-vehicle network central controller 100 recognizes topology information about the in-vehicle component 300 via a message of a control plane, and performs a command to establish a path, in which OpenFlow or a user-defined API protocol may be used.

For reference, Table 1 below shows an example of signal information used for mutual operations of the functional blocks.

TABLE 1

| Signal information | Description |
|---|---|
| Registration | Used upon network connection request from in- |
| Request | vehicle component (component and device) |
| Authentication | Used when in-vehicle component is |
| Request/Response | authenticated |
| Session Establishment | Used when session of in-vehicle component is |
| Request | established |
| Slice Generation | Used upon request to generate dedicated |
| Request | network slicing path |
| DTU size | Used when maximum data size to be used for |
| Request/Response | in-vehicle component is authenticated |
| Dedicated slice | Used when network slicing path is established |
| establishment | in DPF |
| Request/Response | |
| DTU Session | Used when session for data transmission is |
| Establishment | established |

The in-vehicle network device 200 according to an embodiment of the present disclosure may have a configuration including a control message processing unit 210 and a data transfer unit 220 as illustrated in FIG. 2. The control message processing unit 210 performs a function of linking with the in-vehicle network central controller 100 through a control plane communication channel in a control plane of the in-vehicle network.

The data transfer unit 220 performs a function of transferring data of the in-vehicle component 300 by using a data flow table in a data plane of the in-vehicle network.

As described above, main functions (path calculation and routing) and software of the in-vehicle network are performed by the in-vehicle network central controller 100, and the in-vehicle network device 200 functions as a data transmission switch and a hub gateway inside the vehicle.

The in-vehicle network device 200 may be implemented, for example, in a COTS server or a white box switch, and may include an “IVC group I/O gateway” function for an in-vehicle component group (IVC group or ECU group) or be implemented as separate hardware.

The “IVC group I/O gateway” performs a function of converting various communication methods and protocols of the grouped in-vehicle component 300 or the ECUs of the in-vehicle component 300 into Ethernet and transferring data.

In the foregoing in-vehicle network environment according to the embodiment of the present disclosure, the operation of each component and function may be expressed as a four-step QoS-guaranteed operation characteristic of registration, session establishment, dedicated network slicing path establishment, and data transmission of the in-vehicle component 300 in order, and may be expressed as a three-step operation characteristic without QoS guaranteed in which a dedicated network slicing path establishment process is omitted when there is no network slice request.

Hereinafter, the internal configuration of the in-vehicle network central controller 100 for guaranteeing QoS when transmitting data in the in-vehicle network environment according to an embodiment of the present disclosure will be described in more detail.

The control function unit 120 is responsible for a function of registering the in-vehicle component 300.

More specifically, when authentication of the in-vehicle component is completed in response to a registration request from the in-vehicle component 300, the control function unit 120 registers the in-vehicle component 300 in the in-vehicle network by obtaining attribute information about the in-vehicle component.

Viewed from the perspective of the operation of each functional block of FIG. 3 illustrated above, the in-vehicle component 300 transmits the registration request to the CAM, and the CAM performs the authentication of the in-vehicle component 300 in conjunction with the CAGF in response.

Subsequently, when the authentication of the in-vehicle component 300 is completed, the CAM obtains the attribute information about the in-vehicle component 300 in conjunction with the CIM, and then transmits a registration accept to the in-vehicle component 300, thereby completing a procedure for registering the in-vehicle component 300.

The control function unit 120 is also responsible for a function of establishing a session for the in-vehicle component 300.

More specifically, the control function unit 120 establishes a data transmission path for the in-vehicle component 300 on the data plane of the in-vehicle network according to a session establishment request of the in-vehicle component 300 registered in the in-vehicle network.

Viewed from the perspective of the operation of each functional block of FIG. 3 illustrated above, the in-vehicle component 300 transmits the session establishment request to the CAM, and the CAM establishes the data transmission path (session) for the in-vehicle component 300 in conjunction with the DPF in response.

When the data transmission path (session) for the in-vehicle component 300 is completely established, the CAM transmits a session establishment accept to the in-vehicle component 300 to complete a session establishment procedure for the in-vehicle component 300.

In addition, the control function unit 120 is responsible for a function of establishing a dedicated network slicing path for the in-vehicle component 300.

More specifically, the control function unit 120 virtualizes the data transmission path of the in-vehicle component 300 according to a network slicing request of the in-vehicle component 300 for which the data transmission path is established, thereby generating a dedicated network slicing path separated for the in-vehicle component 300.

Here, the control function unit 120 may establish the dedicated network slicing path in which the attribute information (e.g., DTU size) about the in-vehicle component 300 is reflected for the in-vehicle component 300.

Viewed from the perspective of the operation of each functional block of FIG. 3 illustrated above, the in-vehicle network device 200 and the in-vehicle component 300 transmit a slice generation request to the NSSM, and the NSSM identifies a DTU size allocated to the in-vehicle component 300 from the CAM through a DTU size request/response in response.

Next, the NSSM establishes the dedicated network slicing path requested by the in-vehicle component 300 in conjunction with the DPF, and when the dedicated network slicing path is completely established, the NSSM transmits a slice generation accept to the in-vehicle network device 200 and the in-vehicle component 300 to complete a procedure for establishing the dedicated network slicing path.

As mentioned above, the application unit 110 may dynamically group (combine) or separate the in-vehicle component 300 or the ECUs of the in-vehicle component 300 according to common attributes, such as a function, performance, a QoS requirement of data traffic, and a traffic path, at the request of a customer and a vehicle manufacturer.

Therefore, when an in-vehicle component group (IVC group or ECU group) of the common attributes is determined based on the attribute information about the in-vehicle component, the control function unit 120 may generate a dedicated network slicing path for each in-vehicle component group in each area of the vehicle where the in-vehicle network device 200 is disposed.

The data communication unit 130 is responsible for a function of transmitting data of the in-vehicle component 300.

More specifically, when the dedicated networking slice path for the in-vehicle component 300 is completely established, the data communication unit 130 transmits the data of the in-vehicle component 300 through the established dedicated networking slice path.

Viewed from the perspective of the operation of each functional block of FIG. 3 illustrated above, the data of the in-vehicle component 300 is transmitted through the dedicated network slicing path, and the DPF transmits (forwards) a data packet through the dedicated network slicing path in layer 2 and applies QoS (rules for guaranteeing requirements in delay and speed).

This data transmission characteristic of the DPF is also applied equally to the in-vehicle network device 200.

Here, since the in-vehicle network central controller 100 predefines a path in the internal network, transmission of the data does not need an STP algorithm that detects a loop as in the existing communication method, thus reducing the CPU load of a device and preventing a looping phenomenon that may occur when a part or wiring is incorrectly connected.

Therefore, an embodiment of the present disclosure may remove a routing function of calculating a path from the DPF and the in-vehicle network device 200 to reduce delay time due to path calculation in the in-vehicle network, thereby reducing data delay across the entire in-vehicle network.

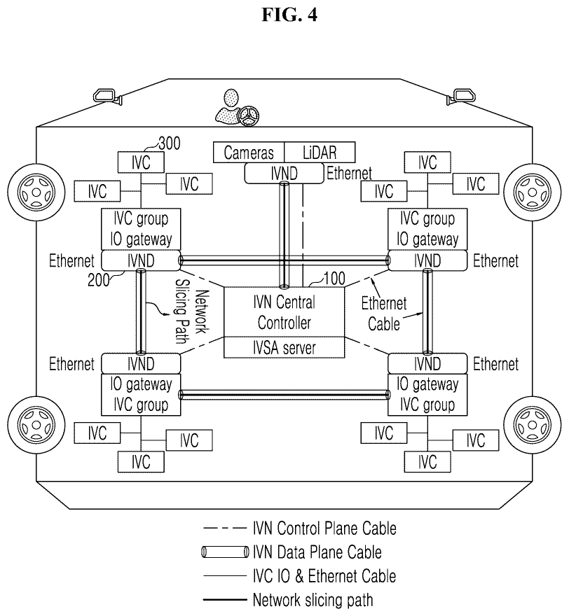

For better understanding of explanation, FIG. 4 illustrates an example of a method of designing an in-vehicle network according to an embodiment of the present disclosure.

The method of designing the in-vehicle network according to the embodiment of the present disclosure considers a design for reducing in-vehicle wiring is considered.

That is, conventionally, vehicle functions are grouped by location within a vehicle, including lighting, a sensor, a motor, and a control device, while grouping of in-vehicle components 300 connected to an IVC group I/O gateway and an in-vehicle network device 200 is dynamically performed through data path control and management of an in-vehicle network central controller 100 according to a SW function or HW function regardless of location in an embodiment of the present disclosure.

An in-vehicle component 300 in each location transmits a control signal and data to a final destination by an IVC group IO gateway and an in-vehicle network device 200 located nearby, and in-vehicle network devices 200 in different locations may also be grouped by common function to shorten a separate cable for connecting to the in-vehicle network central controller 100, enabling a design that minimizes complexity and weight.

An IVC group IO gateway and an in-vehicle network device 200 in each area are connected to the in-vehicle network central controller 100 located in the center of a vehicle and controlled thereby, and not only a data transmission cable for this purpose but also a cable for control and management when necessary may be separately connected, enabling the control and management of the device to be duplexed to operate in a separate network environment even when data traffic increases.

In particular, the cable for control and management may be used as a data cable for emergency recovery when the data cable fails, and as a result, not only communication between areas and functional groups but also end-to-end dedicated path communication between an in-vehicle component 300 and a service without an additional cable for each in-vehicle component 300 is possible with a small number of Ethernet cables through low-latency and high-speed network slicing, thereby reducing the quantity and size of cables to be installed throughout the vehicle.

Further, the method of designing the in-vehicle network according to the embodiment of the present disclosure considers a design centered on the in-vehicle network central controller 100 that enables modularization of the in-vehicle component 300 is considered.

That is, a vehicle cable is a component that causes significant cost and time to manufacture, and an increase in sophistication and saturation of a cable component increase due to adoption of a new technology in accordance with electrification and evolution to an SDV increases

complexity of the cable, and thus a cable connection has a complex form due to a data increase and a control signal requirement, causing significant costs in manufacture and installation.

However, an architecture centered on the in-vehicle network central controller 100 according to an embodiment of the present disclosure simplifies complexity of cables connected to in-vehicle components 300 through network slicing and active grouping by software function.

In addition, instead of connecting each in-vehicle component 300 with a cable that extends according to the entire length of the vehicle, in-vehicle components 300 in each area may be grouped by disposing an IVC group I/O gateway and an in-vehicle network device 200 to enable modular installation, and thus the in-vehicle network central controller 100 controls a plurality of in-vehicle components 300 with a single cable and transmits data by using a dedicated path virtualized by network slicing.

Further, the method of designing the in-vehicle network according to the embodiment of the present disclosure considers a design based on general-purpose hardware utilizing a COTS server or a white box switch.

That is, a connection between the in-vehicle network central controller 100, the IVC group I/O gateway, and the in-vehicle network device 200 implemented in the COTS server or the white box switch may maintain a hardware form regardless of different models and vehicle types.

In addition, the in-vehicle network device 200 and the in-vehicle component 300 may be added to each IVC group I/O gateway in a modular manner and modified, and required software may be added to and virtualized in an in-vehicle service application server 400, a VDF of the in-vehicle network central controller 100, or an application unit 110.

Therefore, an embodiment of the present disclosure enables general use of hardware to operate a software-centered in-vehicle network, thus considerably saving manufacturing time and resources and more easily designing various vehicles being produced in a customer-customized manner.

The method of designing the in-vehicle network according to the embodiment of the present disclosure also considers a software-defined-based design that is easy to update and repair.

That is, the IVC group I/O gateway and the in-vehicle network device 200 according to an embodiment of the present disclosure have a structure in which software is separated from hardware and concentrated in the in-vehicle network central controller 100.

Therefore, a manufacturer may separate software of the in-vehicle component 300 and centralize or virtualize the software in the VDF of the in-vehicle network central controller 100 and the in-vehicle service application server 400.

Using this software-defined-based function may quickly change and update the in-vehicle component 300, the IVC group I/O gateway, and the in-vehicle network device 200 to add or accommodate a new function as needed.

As a result, in the architecture centered on the in-vehicle network central controller 100, a separate in-vehicle component 300, such as a sensor or a motor, may be replaced or added in a plug-and-play manner, and a sub-communication unit for connecting to an external network may be added to the in-vehicle network central controller 100 to remotely update software.

As described above, according to the configuration of the in-vehicle network central controller 100 according to an embodiment of the present disclosure, a dedicated network slicing path may be implemented in an SDV-based in-vehicle network to configure a plurality virtual dedicated networks at the level of a dedicated line in one physical line, making it possible to reduce the number of communication cables in an in-vehicle physical network.

Accordingly, a vehicle manufacturer may reduce the weight of a vehicle, thereby improving battery usage efficiency or reducing the manufacturing cost of the vehicle. Further, it is possible to change data of low capacity to large capacity in real time as needed with a precise network slice bandwidth adjustment technology, thereby efficiently managing network resources inside the vehicle without additional hardware and thus reducing the maintenance cost of the vehicle.

Moreover, a low-latency data transmission technology may be implemented without using a complex and expensive Ethernet technology, such as TSN, making it possible to implement in-vehicle communication for sensitive time control, such as drive-by-wire, at low cost when necessary.

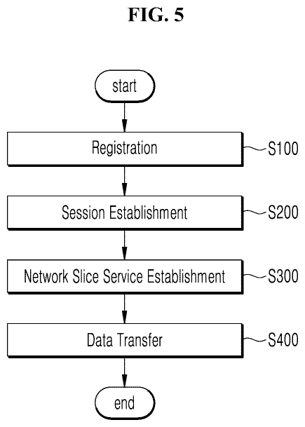

Hereinafter, a method for operating an in-vehicle network according to an embodiment of the present disclosure will be described with reference to FIG. 5.

The method for operating the in-vehicle network according to the embodiment of the present disclosure is to guarantee QoS in data transmission based on establishing a dedicated network slicing path, in which an in-vehicle network central controller 100 will be referred to as an operating entity.

First, the in-vehicle network central controller 100 registers an in-vehicle component 300 in an in-vehicle network (S100).

When authentication of the in-vehicle component is completed in response to a registration request from the in-vehicle component 300, the in-vehicle network central controller 100 may register the in-vehicle component 300 in the in-vehicle network by obtaining attribute information about the in-vehicle component.

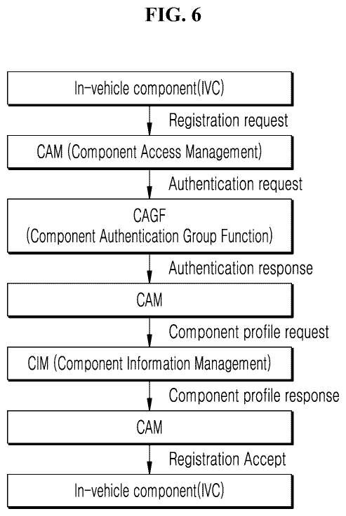

FIG. 6 illustrates the above operation characteristic from the perspective of an operation by functional block.

That is, the in-vehicle component 300 transmits the registration request to a CAM, and the CAM performs the authentication of the in-vehicle component 300 in conjunction with a CAGF in response. Subsequently, when the authentication of the in-vehicle component 300 is completed, the CAM obtains the attribute information about the in-vehicle component 300 in conjunction with a CIM, and then transmits a registration accept to the in-vehicle component 300, thereby completing a procedure for registering the in-vehicle component 300.

The in-vehicle network central controller 100 establishes a session for the in-vehicle component 300 (S200).

The in-vehicle network central controller 100 may establishes a data transmission path for the in-vehicle component 300 on a data plane of the in-vehicle network according to a session establishment request of the in-vehicle component 300 registered in the in-vehicle network.

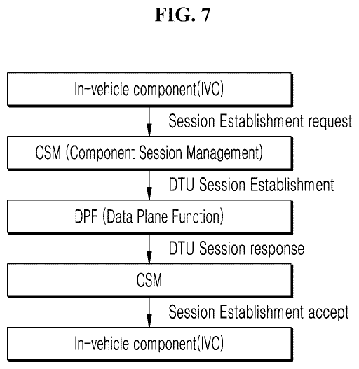

FIG. 7 illustrates the above operation characteristic from the perspective of an operation by functional block.

That is, the in-vehicle component 300 transmits the session establishment request to the CAM, and the CAM establishes the data transmission path (session) for the in-vehicle component 300 in conjunction with a DPF in response. Subsequently, when the data transmission path (session) for the in-vehicle component 300 is completely established, the CAM transmits a session establishment accept to the in-vehicle component 300 to complete a session establishment procedure for the in-vehicle component 300.

The in-vehicle network central controller 100 establishes a dedicated network slicing path for the in-vehicle component 300 (S300).

The in-vehicle network central controller 100 may virtualize the data transmission path of the in-vehicle component 300 according to a network slicing request of the in-vehicle component 300 for which the data transmission path is established, thereby generating a dedicated network slicing path separated for the in-vehicle component 300.

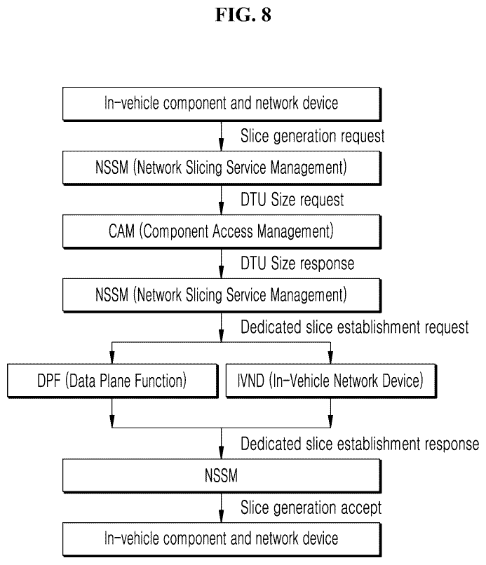

FIG. 8 illustrates the above operation characteristic from the perspective of an operation by functional block.

That is, an in-vehicle network device 200 and an in-vehicle component 300 transmit a slice generation request to an NSSM, and the NSSM identifies a DTU size allocated to the in-vehicle component 300 from the CAM through a DTU size request/response in response. Subsequently, the NSSM establishes the dedicated network slicing path requested by the in-vehicle component 300 in conjunction with the DPF, and when the dedicated network slicing path is completely established, the NSSM transmits a slice generation accept to the in-vehicle network device 200 and the in-vehicle component 300 to complete a procedure for establishing the dedicated network slicing path.

When an in-vehicle component group (IVC group or ECU group) of the common attributes is determined based on the attribute information about the in-vehicle component, the in-vehicle network central controller 100 may generate a dedicated network slicing path for each in-vehicle component group in each area of the vehicle where the in-vehicle network device 200 is disposed.

The in-vehicle network central controller 100 transmits data of the in-vehicle component 300 (S400).

When the dedicated networking slice path for the in-vehicle component 300 is completely established, the in-vehicle network central controller 100 may transmit the data of the in-vehicle component 300 through the established dedicated networking slice path.

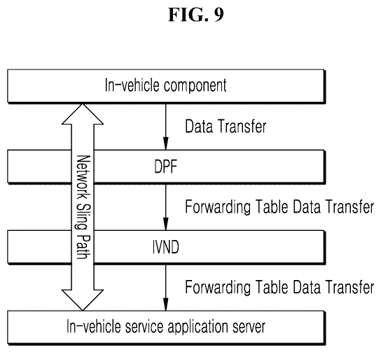

FIG. 9 illustrates the above operation characteristic from the perspective of an operation by functional block.

That is, the data of the in-vehicle component 300 is transmitted through the dedicated network slicing path, and the DPF transmits (forwards) a data packet through the dedicated network slicing path in layer 2 and applies QoS (rules for guaranteeing requirements in delay and speed).

This data transmission characteristic of the DPF is also applied equally to the in-vehicle network device 200.

Here, since the in-vehicle network central controller 100 predefines a path in the internal network, transmission of the data does not need an STP algorithm that detects a loop as in the existing communication method, thus reducing the CPU load of a device and preventing a looping phenomenon that may occur when a part or wiring is incorrectly connected.

Therefore, an embodiment of the present disclosure may remove a routing function of calculating a path from the DPF and the in-vehicle network device 200 to reduce delay time due to path calculation in the in-vehicle network, thereby reducing data delay across the entire in-vehicle network.

As described above, according to the method for operating the in-vehicle network central controller according to an embodiment of the present disclosure, a dedicated network slicing path may be implemented in an SDV-based in-vehicle network to configure a plurality virtual dedicated networks at the level of a dedicated line in one physical line, making it possible to reduce the number of communication cables in an in-vehicle physical network.

Accordingly, a vehicle manufacturer may reduce the weight of a vehicle, thereby improving battery usage efficiency or reducing the manufacturing cost of the vehicle. Further, it is possible to change data of low capacity to large capacity in real time as needed with a precise network slice bandwidth adjustment technology, thereby efficiently managing network resources inside the vehicle without additional hardware and thus reducing the maintenance cost of the vehicle.

Moreover, a low-latency data transmission technology may be implemented without using a complex and expensive Ethernet technology, such as TSN, making it possible to implement in-vehicle communication for sensitive time control, such as drive-by-wire, at low cost when necessary.

The operation method according to an embodiment of the present disclosure may be implemented in a form of program command that may be configured to be executed through various computer means and recorded on a computer readable medium. The computer readable medium may include program commands, data files, data structures, etc. alone or in combination. Program commands recorded on the medium may be specially designed and configured for the present disclosure or known and usable to those skilled in computer software. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program commands, such as ROM, RAM, flash memory, and the like. Examples of program commands include high-level language codes that may be executed by a computer using an interpreter, as well as machine language codes produced by a compiler. The aforementioned hardware device may be configured to function as one or more software modules to perform the operations of the present disclosure, and vice versa.

Although the present disclosure has been described in detail with reference to preferred embodiments, the present disclosure is not limited to the above-described embodiments, and the technical idea of the present disclosure extends to the extent that any person with ordinary knowledge in the technical field to which the present disclosure belongs may make various changes or modifications without departing from the gist of the present disclosure claimed in the following claims.

What is claimed is:

1. An in-vehicle network central controller for controlling an in-vehicle network, the in-vehicle network central controller comprising:
a control function unit configured to establish, in a data plane of the in-vehicle network, a data transmission path for an in-vehicle component registered in the in-vehicle network in a control plane of the in-vehicle network and to generate a dedicated network slicing path separated for the in-vehicle component by virtualizing the data transmission path in order to transmit data of the in-vehicle component.

2. The in-vehicle network central controller of claim 1, wherein the control function unit is configured to register the in-vehicle component in the in-vehicle network by obtaining attribute information about the in-vehicle component when authentication of the in-vehicle component is completed according to a registration request from the in-vehicle component.

3. The in-vehicle network central controller of claim 1, wherein the in-vehicle network comprises an in-vehicle network device configured to transmit data of the in-vehicle component in a data link layer, and the control function unit is configured to generate the dedicated network slicing path in which attribute information about the in-vehicle component is reflected according to a network slicing request from the in-vehicle network device and the in-vehicle component.

4. The in-vehicle network central controller of claim 3, wherein the in-vehicle network device comprises:
a control plane communication channel for linking with the in-vehicle network central controller in the control plane of the in-vehicle network; and
a data flow table for transferring the data of the in-vehicle component in the data plane of the in-vehicle network.

5. The in-vehicle network central controller of claim 1, wherein the control function unit is configured to determine an in-vehicle component group of a common attribute, based on attribute information about the in-vehicle component, and to generate the dedicated network slicing path for each in-vehicle component group.

6. An in-vehicle network operation method performed by an in-vehicle network central controller, the in-vehicle network operation method comprising:
a session establishment operation of establishing, in a data plane of the in-vehicle network, a data transmission path for an in-vehicle component registered in the in-vehicle network in a control plane of the in-vehicle network; and
a slice establishment operation of generating a dedicated network slicing path separated for the in-vehicle component by virtualizing the data transmission path in order to transmit data of the in-vehicle component.

7. The in-vehicle network operation method of claim 6, further comprising a component registration operation of registering the in-vehicle component in the in-vehicle network by obtaining attribute information about the in-vehicle component when authentication of the in-vehicle component is completed according to a registration request from the in-vehicle component.

8. The in-vehicle network operation method of claim 6, wherein the in-vehicle network comprises an in-vehicle network device configured to transmit data of the in-vehicle component in a data link layer, and
wherein the slice establishment operation comprises generating the dedicated network slicing path in which attribute information about the in-vehicle component is reflected according to a network slicing request from the in-vehicle network device and the in-vehicle component.

9. The in-vehicle network operation method of claim 6, wherein the slice establishment operation comprises determining an in-vehicle component group of a common attribute, based on attribute information about the in-vehicle component, and generating the dedicated network slicing path for each in-vehicle component group.

10. A non-transitory computer-readable storage medium storing instructions thereon, the instructions when executed by one or more processors cause the one or more processors to:
establish, in a data plane of an in-vehicle network, a data transmission path for an in-vehicle component registered in the in-vehicle network in a control plane of the in-vehicle network; and
generate a dedicated network slicing path separated for the in-vehicle component by virtualizing the data transmission path in order to transmit data of the in-vehicle component.
